(19) United States
(12) Patent Application Publication
(10) Pub. No.: US 2024/0114372 A1
(43) Pub. Date: Apr. 4, 2024

(54) METHOD AND APPARATUS FOR PERFORMING CELL MEASUREMENT PROCESS

(71) Applicant: Lenovo (Beijing) Limited, Beijing (CN)

(72) Inventors: Min Xu, Beijing (CN); Haiming Wang, Beijing (CN); Lianhai Wu, Beijing (CN); Jie Shi, Beijing (CN); Jing Han, Beijing (CN); Ran Yue, Beijing (CN); Jie Hu, Beijing (CN)

(73) Assignee: Lenovo (Beijing) Limited, Beijing (CN)

(21) Appl. No.: 18/264,199

(22) PCT Filed: Feb. 4, 2021
(86) PCT No.: PCT/CN2021/075290

§ 371 Date: Aug. 3, 2023

(51) Int. Cl. H04W 24/10; H04W 36/00; H04W 36/04

(52) U.S. Cl. CPC H04W 24/10; H04W 36/0072; H04W 36/0085; H04W 36/04

(57) ABSTRACT

The present application relates to a method and an apparatus for performing cell measurement process. One embodiment of the present disclosure provides a method performed by a method performed by a User Equipment (UE) in a wireless network with a variable coverage, comprising: performing a cell measurement process of one or more cells of the wireless network; and in response to a variation in the coverage of the wireless network in relation to the UE, disabling the cell measurement process of the one or more cells of the wireless network.

### TECHNICAL FIELD

The present disclosure relates to 3rd Generation Partnership Project (3GPP) 5G wireless communication technology, especially to a method and an apparatus for discontinuous coverage or variable coverage.

### BACKGROUND OF THE INVENTION

In a network with discontinuous coverage or variable coverage, the UE may be located in the area or in the time period with no available serving cell. In this case, the cell measurement process performed by a user equipment (UE) is useless and power consuming.

Therefore, it is desirable to provide a solution to improve the current cell measurement mechanism taking the network with discontinuous coverage or variable coverage into consideration.

### SUMMARY

One embodiment of the present disclosure provides a method performed by a method performed by a User Equipment (UE) in a wireless network with a variable coverage, comprising: performing a cell measurement process of one or more cells of the wireless network; and in response to a variation in the coverage of the wireless network in relation to the UE, disabling the cell measurement process of the one or more cells of the wireless network.

In one embodiment, the variation in the coverage of the wireless network in relation to the UE is associated with the coverage of the wireless network being discontinued.

In one embodiment, the wireless network is a non-terrestrial network (NTN).

In one embodiment, the cell measurement process relates to at least one of: measuring a serving cell of the UE, searching for and/or measuring signal strength of a neighboring cell of the serving cell, or searching for and/or measuring signal strength of a suitable cell.

In one embodiment, the method further comprises: determining coverage information of the wireless network or receiving the coverage information from the wireless network, wherein the coverage information of the wireless network includes at least one of the following information: a first indication for indicating an area of a serving cell of the UE where cell quality is below a first threshold; a first time duration when the cell quality is below the first threshold; a second indication for indicating an area where cell quality is above a second threshold; a second time duration when the cell quality is above the second threshold; a third indication for enabling or disabling the cell measurement process; a third time duration for enabling or disabling the cell measurement process; a first offset of a measured cell quality value; a first offset duration for applying the first offset of the measured cell quality value; a second offset of a measured cell quality value threshold; a second offset duration for applying the second offset of the measured cell quality value threshold; a third offset of a measured cell quality tolerance threshold; a third offset duration for applying the third offset of the measured cell quality tolerance threshold; and a maximum time duration between a last cell measurement process and a current cell measurement process.

In one embodiment, the method further comprises: transmitting a request for the coverage information in at least one of the following procedures: a radio resource control (RRC) establishment procedure; a RRC re-establishment procedure; a RRC resume procedure; a RRC reconfiguration procedure; a RRC release procedure; a RRC attach procedure; a RRC de-attach procedure; or a tracking area update (TAU) procedure.

In one embodiment, the coverage information is received from the wireless network, and the coverage information is included in a message during at least one of the following procedures: a RRC establishment procedure, a RRC re-establishment procedure, a RRC resume procedure, a RRC reconfiguration procedure, a RRC release procedure, a RRC attach procedure, a RRC de-attach procedure or a TAU procedure, or transmitted in system information broadcast.

In one embodiment, the method further comprises: receiving modification information for the coverage information of the wireless network being associated with the variable coverage during at least one of the following procedures: a RRC establishment procedure; a RRC re-establishment procedure; a RRC resume procedure; a RRC reconfiguration procedure; a RRC release procedure; a RRC attach procedure; a RRC de-attach procedure; or a TAU procedure.

In one embodiment, the method further comprises: activating a first timer when a cell quality of the wireless network is below a first threshold, or at a time indicated by a first time duration, or when the UE enters an idle mode.

In one embodiment, the method further comprises: stopping the cell measurement process when the first timer is running.

In one embodiment, the method further comprises: performing the cell measurement process when the first timer is not running or before transmitting uplink data within the wireless network.

In one embodiment, the method further comprises at least one of the following: applying the first offset to the measured cell quality value; applying the second offset to the measured cell quality value threshold; and applying the third offset to the measured cell quality tolerance threshold.

In one embodiment, the method further comprises at least one of the following: applying the first offset to the measured cell quality value within the first offset duration; applying the second offset to the measured cell quality value threshold within the second offset duration; and applying the third offset to the measured cell quality tolerance threshold within the third offset duration.

In one embodiment, the method further comprises: transmitting, to the wireless network, a third indication indicating whether the UE is capable of performing the cell measurement process.

In one embodiment, the method further comprises: transmitting, to the wireless network, a fourth indication indicating whether coverage information determined by the UE is available coverage information is applied for performing the cell measurement process or not.

In one embodiment, the method further comprises: transmitting, to the wireless network, the coverage information determined by the UE in at least one of the following procedures: a RRC establishment procedure; a RRC re-establishment procedure; a RRC resume procedure; a RRC reconfiguration procedure; a RRC release procedure; a RRC attach procedure; a RRC de-attach procedure; or a TAU procedure.

Another embodiment of the present disclosure provides a method performed by a base station (BS) in a wireless network with a variable coverage, comprising: transmitting, to one or more User Equipment (UE), coverage information of one or more cells that are associated with the wireless network in relation to the one or more UE; and in response to a variation in the coverage of the wireless network in relation to one or more UE, transmitting the coverage information of the one or more cells, wherein the coverage information is associated with the variation in the coverage of the wireless network in relation to the one or more UE.

In one embodiment, the variation in the coverage of the wireless network in relation to the UE is associated with the coverage of the wireless network being discontinued.

In one embodiment, the wireless network is a non-terrestrial network (NTN).

In one embodiment, the coverage information includes at least one of the following: a first indication for indicating an area of a serving cell of the UE where cell quality is below a first threshold; a first time duration when the cell quality is below the first threshold; a second indication for indicating an area where cell quality is above a second threshold; a second time duration when the cell quality is above the second threshold; a third indication for enabling or disabling the cell measurement process; a third time duration for enabling or disabling the cell measurement process; a first offset of a measured cell quality value; a first offset duration for applying the first offset of the measured cell quality value; a second offset of a measured cell quality value threshold; a second offset duration for applying the second offset of the measured cell quality value threshold; a third offset of a measured cell quality tolerance threshold; a third offset duration for applying the third offset of the measured cell quality tolerance threshold; and a maximum time duration between a last cell measurement process and a current cell measurement process.

In one embodiment, the method further comprises: receiving a request from the one or more UE for the coverage information in at least one of the following procedures: a radio resource control (RRC) establishment procedure; a RRC re-establishment procedure; a RRC resume procedure; a RRC reconfiguration procedure; a RRC release procedure; a RRC attach procedure; a RRC de-attach procedure; or a tracking area update (TAU) procedure.

In one embodiment, the coverage information is transmitted to the one or more UE during at least one of the following procedures: a RRC establishment procedure, a RRC re-establishment procedure, a RRC resume procedure, a RRC reconfiguration procedure, a RRC release procedure, a RRC attach procedure, a RRC de-attach procedure or a TAU procedure, or transmitted in system information broadcast.

In one embodiment, the method further comprises: transmitting modification information for the coverage information of the wireless network being associated with the variable coverage during at least one of the following procedures: a RRC establishment procedure; a RRC re-establishment procedure; a RRC resume procedure; a RRC reconfiguration procedure; a RRC release procedure; a RRC attach procedure; a RRC de-attach procedure; or a TAU procedure.

In one embodiment, the method further comprises: receiving a third indication indicating whether the one or more UE is capable of performing the cell measurement process.

In one embodiment, the method further comprises: receiving a fourth indication indicating whether the coverage information determined by the UE is available coverage information is applied for performing the cell measurement process or not.

Still another embodiment of the present disclosure provides a User Equipment, comprising: a processor; and a transceiver coupled to the processor, wherein the processor is configured to perform a cell measurement process of one or more cells of the wireless network; and in response to a variation in the coverage of the wireless network in relation to the UE, disable the cell measurement process of the one or more cells of the wireless network.

Still another embodiment of the present disclosure provides a Base Station, comprising: a processor; and a transceiver coupled to the processor, wherein the processor is configured to transmit, to a one or more User Equipment (UE), coverage information of one or more cells that are associated with the wireless network in relation to the one or more UE; and in response to a variation in the coverage of the wireless network in relation to one or more UE, transmit the coverage information of the one or more cells, wherein the coverage information is associated with the variation in the coverage of the wireless network in relation to the one or more UE.

### BRIEF DESCRIPTION OF THE DRAWINGS

FIG. 1 illustrates a schematic diagram of a wireless communication system according to some embodiments of the present disclosure.

FIG. 2 illustrates a flow chart of a method for performing cell measurement process according to some embodiments of the present disclosure.

FIG. 3 illustrates a method for performing cell measurement process according to some embodiments of the present disclosure.

FIG. 4 illustrates a block diagram of a UE according to the embodiments of the present disclosure.

FIG. 5 illustrates a block diagram of a BS according to the embodiments of the present disclosure.

### DETAILED DESCRIPTION

The detailed description of the appended drawings is intended as a description of the currently preferred embodiments of the present invention, and is not intended to represent the only form in which the present invention may be practiced. It should be understood that the same or equivalent functions may be accomplished by different embodiments that are intended to be encompassed within the spirit and scope of the present invention.

While operations are depicted in the drawings in a particular order, persons skilled in the art will readily recognize that such operations need not be performed in the particular order shown or in sequential order, or that all illustrated operations be performed, to achieve desirable results, sometimes one or more operations can be skipped. Further, the drawings can schematically depict one more example processes in the form of a flow diagram. However, other operations that are not depicted can be incorporated in the example processes that are schematically illustrated. For example, one or more additional operations can be performed before, after, simultaneously, or between any of the illustrated operations. In certain circumstances, multitasking and parallel processing can be advantageous.

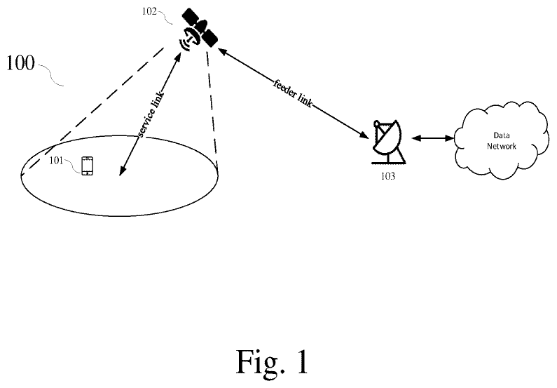

FIG. 1 depicts an exemplary NTN network in which techniques disclosed herein may be implemented, in accordance with some embodiments of the present disclosure.

The NTN network refers to networks, or segments of networks, using an airborne or space-borne vehicle to embark an NTN payload. The NTN payload performs the desired communication function of the satellite (respectively high altitude platform station (HAPS)) between the service and the feeder link. It is embarked on board space/airborne vehicle. The HAPS refers to airborne vehicle embarking the NTN payload placed at an altitude between 8 and 50 km.

As shown in FIG. 1, the NTN network 100 includes at least one user equipment (UE) 101 and at least one satellite BS 102, or alternatively a UAS platform 102. Although only one UE 101 and a satellite/UAS platform 102 are depicted in FIG. 1, it is contemplated that any number of UEs 101 and satellites/UAS platforms 102 may be included in the wireless communication system 100.

The UE 101 may include computing devices, such as desktop computers, laptop computers, personal digital assistants (PDAs), tablet computers, smart televisions (e.g., televisions connected to the Internet), set-top boxes, game consoles, security systems (including security cameras), vehicle on-board computers, network devices (e.g., routers, switches, modems), or the like. According to an embodiment of the present disclosure, the UE 101 may include a portable wireless communication device, a smart phone, a cellular telephone, a flip phone, a device having a subscriber identity module, a personal computer, a selective call receiver, or any other device that is capable of sending and receiving communication signals on a wireless network. In some embodiments, the UE 101 includes wearable devices, such as smart watches, fitness bands, optical head-mounted displays, or the like. Moreover, the UE 101 may be referred to as subscriber units, mobiles, mobile stations, users, terminals, mobile terminals, wireless terminals, fixed terminals, subscriber stations, user terminals, a device, or by other terminology used in the art. The UE 101 may communicate directly with the satellite BS 102 via service link.

Satellite(s) BS 102 may include low earth orbiting (LEO) satellites, medium earth orbiting (MEO) satellites, geostationary earth orbiting (GEO) satellites, as well as highly elliptical orbiting (HEO) satellites. UAS platform(s) 102 may include unmanned aircraft systems (UAS) including tethered UAS and lighter than air UAS (LTA), Heavier than air UAS (HTA), and high altitude platforms UAS (HAPs). For convenience, we will use satellite 102 hereinafter to elaborate the present disclosure. However, persons skilled in the art can know that the same technique may also be applied to UAS platform(s).

Referring still to FIG. 1, the satellite 102 provides a geographic cell for serving UE 101 located in the geographic cell. In FIG. 1, example UE may be a normal mobile terminal 101, which can wirelessly communicate with the satellite/UAS platform 102 via a communications link, such as service link or radio link in accordance with a NR access technology (e.g., a NR-Uu interface). As also shown in FIG. 1, the satellite 102 also communicates with a gateway 103 or earth station via a communication link, which may be a feeder link or radio link in accordance with NR access technologies or other technologies. In accordance with various embodiments, the satellite 102 may be implemented with either a transparent or a regenerative payload. When the satellite carries a “transparent” payload, it performs only radio frequency filtering, frequency conversion and/or amplification of signals on board. Hence, the waveform signal repeated by the payload is un-changed. When a satellite carries a regenerative payload, in addition to performing radio frequency filtering, frequency conversion and amplification, it performs other signal processing functions such as demodulation/decoding, switching and/or routing, coding/decoding and modulation/demodulation on board as well. In other words, for a satellite with a regenerative payload (re, all or part of base station functions (e.g., a gNB, eNB, etc.) are implemented on board.

A typical terrestrial communication network includes one or more base stations (typically known as a “BS”) that are located on earth (i.e., not airborne or spaceborne) that each provides geographical radio coverage, and UEs that can transmit and receive data within the radio coverage. In the terrestrial communication network, a BS and a UE can communicate with each other via a communication link, e.g., via a downlink radio frame from the BS to the UE or via an uplink radio frame from the UE to the BS.

Returning back to FIG. 1, the gateway 103 may be coupled to a data network such as, for example, the Internet, terrestrial public switched telephone network, mobile telephone network, or a private server network, etc. Gateway 103 and the satellite 102 communicate over a feeder link, which has both a feeder uplink from the gateway 103 to the satellite 102 and a feeder downlink from the satellite 102 to the gateway 103. Although a single gateway 103 is shown, some implementations will include many gateways, such as five, ten, or more. One embodiment includes only one gateway. UE 101 and satellite 102 communicate over service link, which has both an uplink from the UE 101 to the BS 102 and a downlink from the BS 102 to the UE 101.

In some embodiments, communication within the system of FIG. 1 follows a nominal roundtrip direction whereby data is received by gateway from data network (e.g., the Internet) and transmitted over a forward path to a set of UE 101. In one example, communication over the forward path comprises transmitting the data from gateway to satellite 102 via uplink of the feeder link, through a first signal path on satellite, and from satellite 102 to UE(s) 101 via downlink of the service link. Data can also be sent from the UEs 101 over a return path to gateway. In one example, communication over the return path comprises transmitting the data from a UE (e.g., UE 101a) to satellite 102 via uplink of the service link, through a second signal path on satellite 102, and from satellite 102 to gateway via downlink of the feeder link.

The wireless communication system 100 is compliant with any type of network that is capable of sending and receiving wireless communication signals. For example, the wireless communication system 100 is compliant with a wireless communication network, a cellular telephone network, a time division multiple access (TDMA)-based network, a code division multiple access (CDMA)-based network, an orthogonal frequency division multiple access (OFDMA)-based network, a LTE network, a 3rd generation partnership project (3GPP)-based network, 3GPP 5G network, a satellite communications network, a high altitude platform network, and/or other communications networks.

In one implementation, the wireless communication system 100 is compliant with the NR of the 3GPP protocol, wherein the BS 102 transmits using an OFD modulation scheme on the DL and the UE 101 transmits on the UL using a single-carrier frequency division multiple access (SC-FDMA) scheme or OFDM scheme. More generally, however, the wireless communication system 100 may implement some other open or proprietary communication protocol, for example, WiMAX, among other protocols.

In other embodiments, the BS 102 may communicate using other communication protocols, such as the IEEE 802.11 family of wireless communication protocols. Further, in some embodiments the BS 102 may communicate over licensed spectrum, while in other embodiments the BS 102 may communicate over unlicensed spectrum. The present disclosure is not intended to be limited to the implementation of any particular wireless communication system architecture or protocol. In another embodiment, the BS 102 may communicate with the UE 101 using the 3GPP 5G protocols.

In some scenarios, the microsatellite platforms, i.e., the cube satellites, with limited size and power and low-density constellations, which have restricted link budget and discontinuous service link coverage where UE devices may remain long periods of time without being able to detect a satellite cell.

For NTN, the discontinuous service link coverage may happen in space and/or time domain due to the movement of the satellite and/or the movement of the UE.

For instance, in FIG. 1, the UE 101 may not be able to detect the satellite cell of the satellite 102 when the satellite 102 moves to other locations, and the UE 101 may detect the satellite cell of the satellite 102 when the satellite 102 moves back. That is, the service link coverage is discontinuous in time domain. Alternatively, the UE 101 may move outside the coverage of the satellite 102, and the service link is discontinuous in space domain. In other words, the service coverage of the BS is variable. The variable coverage may happen in the following scenarios: an early stage 5G network, a private network, a network providing coverage with moving BSs or relays, a BS located on a hot balloon, a BS located on a drone, etc.

When the UE is out of coverage a cell, the UE may perform a cell selection procedure.

According to current specification, when the serving cell becomes unavailable, the UE may keep on scanning all RF channels until a suitable or an acceptable cell is found. Clearly, scanning all RF channels is power consuming. However, in a network with discontinuous coverage or variable coverage, scanning all RF channels is useless in the time period when there is no cell coverage, or in the location area where there is no cell coverage.

Currently, for cell reselection of UE other than narrow band internet of things (NB-IoT), the 3GPP documents define following content:

When evaluating the measured RSRP (which is represented as Srxlev)
and the measured RSRQ (which is represented as Squal) of non-serving
cells for reselection purposes, the UE shall use parameters provided
by the serving cell.
Following rules are used by the UE to limit needed measurements:

| | |
|---|---|
| - | If the serving cell fulfils Srxlev > |
| | S_{IntraSearchP} and Squal > S_{IntraSearchQ}, the UE may choose not to |
| | perform intra-frequency measurements. |
| - | Otherwise, the UE shall perform intra-frequency measurements. |
| - | The UE shall apply the following rules for E-UTRAN |
| | inter-frequencies and inter-RAT frequencies which are indicated |
| | in system information and for which the UE has priority |
| | provided as defined in 5.2.4.1: |

| | |
|---|---|
| - | For an E-UTRAN inter-frequency or inter-RAT frequency |
| | with a reselection priority higher than the reselection |
| | priority of the current E-UTRA frequency the UE shall perform |
| | measurements of higher priority E-UTRAN inter-frequency or |
| | inter-RAT frequencies according to TS 36.133 [10]. |
| - | For an E-UTRAN inter-frequency with an equal or lower |
| | reselection priority than the reselection priority of the |
| | current E-UTRA frequency and for inter-RAT frequency with |
| | lower reselection priority than the reselection priority of the |
| | current E-UTRAN frequency: |

| | |
|---|---|
| - | If the serving cell fulfils Srxlev > S_{nonIntraSearchP} and Squal > |
| | S_{nonIntraSearchQ}, the UE may choose not to perform |
| | measurements of E-UTRAN inter-frequencies or inter-RAT |
| | frequency cells of equal or lower priority unless the UE is |
| | triggered to measure an E-UTRAN inter-frequency which |
| | is configured with redistributionInterFreqInfo. |
| - | Otherwise, the UE shall perform measurements of |
| | E-UTRAN inter-frequencies or inter-RAT frequency cells |
| | of equal or lower priority according to TS 36.133 [10]. |

| | |
|---|---|
| - | If the UE supports relaxed monitoring and s-SearchDeltaP is present |
| | in SystemInformationBlockType3, the UE may further limit the |
| | needed measurements, as specified in clause 5.2.4.12. |

For cell reselection of NB-IoT, the 3GPP documents define following content:

When evaluating Srxlev and Squal of non-serving cells for reselection
purposes, the UE shall use parameters provided by the serving cell.
Following rules are used by the UE to limit needed measurements:

| | |
|---|---|
| - | If the serving cell fulfils Srxlev > S_{IntraSearchP}, the UE may |
| | choose not to perform intra-frequency measurements. |
| - | Otherwise, the UE shall perform intra-frequency measurements. |
| - | The UE shall apply the following rules for NB-IoT inter-frequencies |
| | which are indicated in system information: |

| | |
|---|---|
| - | If the serving cell fulfils Srxlev > S_{nonIntraSearchp}, the UE may |
| | choose not to perform inter-frequency measurements. |
| - | Otherwise, the UE shall perform inter-frequency measurements. |

| | |
|---|---|
| - | If the UE supports relaxed monitoring and s-SearchDeltaP is present |
| | in SystemInformationBlockType3-NB, the UE may further limit the |
| | needed measurements, as specified in clause 5.2.4.12. |

In view of the above, for the UE other than the NB-IoT, when the serving cell quality is lower than a predefined threshold, the UE may always perform the serving cell measurement process and the neighboring cell measurement process. Therefore, in a network with discontinuous coverage or variable coverage, when the serving cell is unavailable, for example, the satellite moves to other locations, and there is no neighboring cell, which means there is also no suitable or acceptable cell. Thus the UE would keep on measuring or scanning before and after the UE entering the “Any Cell Selection” state.

For the NB-IoT UE, it also keeps on measuring or scanning before and after entering the “Any Cell Selection” state. Compared with the UE other than NB-IoT, the cell quality threshold determined by the NB-IoT only includes reference signal receiving power (RSRP) and inter-frequency or radio access technology (RAT) measurement is not considered.

For NB-IoT UE, the relaxed monitoring is introduced to further reduce power consumption with the intention to avoid triggering measurement when the serving cell quality decline is not significant, the serving cell quality decline may be calculated as follows:

Srxlev_{Ref}−Srxlev<S_{SearchDeltaP}

wherein Srxlev_{Ref} is a reference of the Srxlev, and Srxlev is the measured RSRP, and S_{SearchDeltaP} is the cell quality tolerance, the value of S_{SearchDeltaP} may be 6, 9, 12, 15 dB.

The relaxed monitoring lasts for a period of time, i.e., T_{SearchDeltaP}=max {5 min, extended discontinuous reception (eDRX) cycle if configured)}.

To use relaxed monitoring, it is also required that less than 24 hours have passed since measurements for cell reselection were last performed and the UE has performed intra-frequency or inter-frequency measurements for at least the timer period, T_{SearchDeltaP} after selecting or reselecting a new cell.

Accordingly, the relaxed monitoring is a trade-off between cell quality decline and measurement triggering, but not for discontinuous coverage or variable coverage. To leverage relaxed monitoring for discontinuous coverage or variable coverage, the cell quality tolerance S_{SearchDeltaP} has to be large enough. For example, the difference between there is coverage and there is no coverage, the cell quality tolerance may be the maximum RSRP minus zero, thus, the cell quality tolerance S_{SearchDeltaP} may be set to the maximum RSRP possible, and this forbids further measurement. Meanwhile T_{SearchDeltaP} is set to at least 5 minutes at present for power saving. Besides, the maximum duration of relaxed monitoring is 24 hours.

The relaxed monitoring are not suitable for the discontinuous or variable coverage scenario, because the value range of the cell quality tolerance, i.e., 6, 9, 12, 15 dB, is limited, and when the UE is out of coverage, the maximum quality tolerance, i.e., 15 dB, may be less than the difference between the measured serving cell RSRP minus 0 (no measured RSRP). Furthermore, the period of time T_{SearchDeltaP}, which is at least 5 min and every 24 hours, is also too limited to be applied in the discontinuous or variable coverage scenario.

In view of the above, the discontinuous service link coverage may lead to additional and unnecessary power consumption. For some devices, the additional and unnecessary power consumption may be essential, such as the IoT devices. Meanwhile the regular trajectory of NTN platforms (e.g., LEO satellite) as well as the low mobility of IoT devices provides room for enhancement.

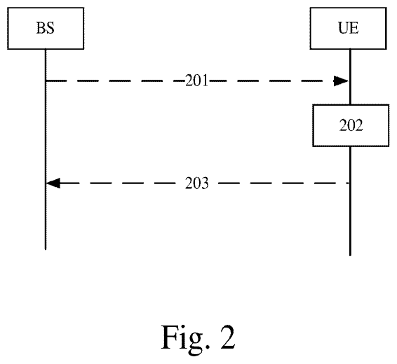

FIG. 2 proposes a solution for solving the above issues and provides enhancements for the network with discontinuous coverage or variable coverage. Specifically, FIG. 2 illustrates a flow chart of a method for performing cell measurement process according to some embodiments of the present disclosure.

In step 201, the BS, or the network, transmit the coverage information associated with a network with discontinuous coverage or variable coverage. It is noted that this step may not always exist, because in some scenarios, the UE may determine the coverage information itself.

In step 202, the UE determines the coverage information associated with a network with discontinuous coverage or variable coverage.

For instance, the UE may perform a cell measurement process to estimate the coverage information of the network, for example, the geographic location of the network coverage and/or the time period when the network coverage is available based on the location of the UE by itself. Or, the UE may perform a cell measurement process based on other known information, such as the satellite ephemeris, the satellite coverage, and/or the network deployment.

Based on different cell measurement parameters, there are at least three different types of cell measurement, which are presented as follows:
1. The cell measurement process of a suitable cell or an acceptable cell on a dedicated public land mobile network (PLMN) or frequency band, or on all supported PLMNs or all frequency bands. The first type of cell measurement process may be used for cell selection.
2. The cell measurement process of a serving cell on a dedicated PLMN or frequency band. The second type of cell measurement process may trigger the neighbouring cell measurement, which may be used for cell reselection.
3. The cell measurement process of a neighbouring cell on a dedicated PLMN or frequency band, or on all supported PLMNs or all frequency bands. The third type of cell measurement process may be used for cell reselection.

Specifically, the coverage information may include at least one of the following parameters:
1. An area where the cell quality is below the first threshold, that is, the network does not have good DL signal or no DL signal in this area, and the network coverage is week or absent;
2. An area where the cell quality is above the second threshold, that is, the network has good DL signal in this area, and the network coverage is good;
3. The first time duration when the cell quality is below the first threshold;
4. The second time duration when the cell quality is above the second threshold;
5. An indication for activating (may also be called enabling) or deactivating (may also be called disabling) at least one type of cell measurement.
6. A time duration for activating (may also be called enabling) or deactivating (may also be called disabling) at least one type of cell measurement;
7. The first offset of the measured cell quality value, for instance, the measured cell quality value may be the measured RSRP (which is represented with Srxlev) of the serving cell, measured RSRQ (which is represented with Squal) of the serving cell, the measured RSRP of the neighboring cell, or the measured RSRQ of the neighboring cell, or any other parameters that are able to reflect the cell quality of the serving cell or the neighboring cell;
8. The first offset duration for applying the first offset;
9. The second offset of a measured cell quality value threshold, for example, the measured cell quality value threshold may be the measured RSRP threshold (which is represented with S_{IntraSearchP} or S_{nonIntraSearchP}) of the serving cell, measured RSRQ threshold (which is represented with S_{IntraSearchQ} or S_{nonIntraSearchQ}) of the serving cell, the measured RSRP threshold of the neighboring cell, or the measured RSRQ threshold of the neighboring cell, or any other parameters that are able to reflect the cell quality threshold of the serving cell or the neighboring cell;
10. The second offset duration for applying the second offset;
11. The third offset of a measured cell quality tolerance threshold. The third offset is applied to the cell quality tolerance threshold which is used when the UE is in the relaxed monitoring, i.e., the cell quality tolerance threshold, which is represented with S_{SearchDeltaP}.
12. The third offset duration for applying the third offset, which is represented with T_{SearchDeltaP}; and
13. The maximum time duration between the last cell measurement process and the current cell measurement process, for example, 1 hour, 2 hours, or 24 hours, etc.

After the cell measurement, the UE obtains the coverage information, and may report coverage information to the network in step 203. For example, the UE may be an aerial base station (ABS), in this case, the ABS may report the geographic location of the network coverage provided by itself and/or the time period during when the ABS would be providing service, to the network. The UE may further report other relevant content to the network, such as the motion track of the UE, the speed of the UE, etc.

The UE may report the coverage information to the network during the radio resource control (RRC) establishment process, the RRC re-establishment process, the RRC resume process, the RRC reconfiguration process, the RRC release process, the RRC attach process, the RRC de-attach process, or tracking area update (TAU) process.

In some other embodiments, the UE may request the coverage information from the network.

At BS side, the BS determines the coverage information based on the deployment, such as the satellite ephemeris or coverage, or based on the UE report. In particular, the BS may estimate the geographic location of the coverage of the serving cell and/or the time period when the coverage of the serving cell is available. The BS then may transmit the geographic location and/or the time period to the UE, (for example, in step 201), during the RRC establishment process, the RRC re-establishment process, the RRC resume process, the RRC reconfiguration process, the RRC release process, the RRC attach process, the RRC de-attach process, the TAU process, or in system information broadcast. It should be noted that the network may not know the exact location of a specific UE.

In some other scenarios, the network may modify or reconfigure the coverage information. For instance, the network may receive the coverage information determined by the UE (for example, in step 203), and adjust the coverage information correspondingly, in this case, the network may transmit the modification or reconfiguration of the coverage information to the UE during the RRC establishment process, the RRC re-establishment process, the RRC resume process, the RRC reconfiguration process, the RRC release process, the RRC attach process, the RRC de-attach process, the TAU process, or in system information broadcast.

Base on the coverage information, the UE may perform at least one of the following actions:
1. The UE may start a first timer when it enters the coverage area with the cell quality being below the first threshold; or when the present time is within the first time duration when the cell quality is below the first threshold; or when the UE enters the IDLE mode, which may be indicated by the expiry of the timer T301.
2. The UE may start a second timer when it enters the coverage area with the cell quality being above the first threshold; or when the present time is within the second time duration when the cell quality is above the first threshold.
3. The UE may disable or enable at least one type of cell measurement.
4. The UE may disable or enable at least one type of cell measurement process when a timer is running, or when the timer expires.
5. The UE may enable at least one type of cell measurement process when the UE is about to perform uplink data transmission.
6. The UE may apply the first offset of the measured cell quality value; and the UE may apply the first offset during the first offset duration. For example, the UE may apply the offset to the measured RSRP of the neighboring cell, Srxlev; and/or measured RSRQ of the neighboring cell, Squal, or any other parameters that are able to reflect the cell quality of the serving cell or the neighboring cell.
   The UE may apply the first offset for cell reselection when a timer runs, and may not apply the first offset when a timer expires or when there is uplink data to transmit.
7. The UE may apply the second offset of the measured cell quality value threshold; the UE may apply the second offset during the second offset duration. For example, the UE may apply the second offset to the measured RSRP threshold of the neighboring cell, which includes the intra frequency search signal strength, S_{IntraSearchP}, and the non intra frequency search signal strength, S_{nonIntraSearchP}, and/or to the measured RSRQ threshold of the neighboring cell, which includes the intra frequency search signal strength, S_{IntraSearchQ} and the non intra frequency search signal strength, S_{nonIntraSearchQ}.
   The UE may apply the second offset for cell reselection when a timer runs, and may not apply the second offset when a timer expires or when there is uplink data to transmit.
8. The UE may apply the third offset to the measured cell quality tolerance threshold, which is represented with S_{SearchDeltaP}; the UE may apply the third offset during the third offset duration. The third offset is applied for at least one type of cell measurement, and is applied when a timer is running, and is not applied when the timer expires, or when the UE is about to perform uplink data transmission.

In some embodiments, the UE may report to the network that the coverage information is available, i.e., report the availability of the coverage information to the BS.

In some embodiments, the UE may report the capability of disabling/enabling at least one type of cell measurement process to the network. The UE may report the request of disabling or enabling at least one type of cell measurement process to the network during the RRC establishment process, the RRC re-establishment process, the RRC resume process, the RRC reconfiguration process, the RRC release process, the RRC attach process, the RRC de-attach process, the TAU process.

In some cases, after receiving the coverage modification from the BS, the UE may accept or reject it, then the UE may report to the network that the UE accepts or rejects the coverage information or the coverage modification indicated by the network.

The present disclosure further provides some scenarios of the UE's behaviors, and some modification may be incorporated in the pending 3GPP documents as follows.

In the first preferred scenario, supposing that the UE is located in an area where the cell quality of a network coverage is below the first threshold, that is, the DL signal is not good or even absent, and/or the present time is within a time duration when the cell quality of a network coverage is below the first threshold, wherein the area information and/or the time period information is estimated by the UE itself or indicated to the UE by the BS or by the network. The UE may perform the following actions:

The UE may start the timer which indicates that there is no service, such as: timer T_{noService}, based on UE location, speed or mobility state, or upon the network configuration, or at the start time estimated by UE or configured by network.

The UE may not perform any type of coverage measurement, which includes at least one type of coverage measurement indicated above when the timer T_{noService} is running.

The UE may stop the timer T_{noService} when the timer expires, or based on UE location, speed, mobility state or upcoming data to transmit. Or, upon the network configuration, the UE stops the timer T_{noService}.

The UE may report the capability of disabling or enabling at least one type of cell measurement process to the network.

The UE may report the availability of estimated T_{noService} to the network.

During the RRC establishment process, the RRC re-establishment process, the RRC resume process, the RRC reconfiguration process, the RRC release process, the RRC attach process, the RRC de-attach process, or the TAU process, the UE may report the estimated T_{noService} to the network; or the UE may report the request of disabling/enabling at least one type of cell measurement process in T_{noService} to the network.

The UE may report to the network the acceptance or rejection of T_{noService} indicated by the network.

The cell selection procedure in the 3GPP documents, for example, TS36.304, may be modified as follows (the modifies parts are underlined):

```
5.2.3.1 Description
The UE shall use one of the following two cell selection procedures:
    a) Initial Cell Selection
      This procedure requires no prior knowledge of which RF channels
      are E-UTRA or NB-IoT carriers. The UE shall scan all RF
      channels in the E-UTRA bands according to its capabilities to find
      a suitable cell. On each carrier frequency, the UE need only search
      for the strongest cell. Once a suitable cell is found this cell
      shall be selected.
    b) Stored Information Cell Selection
      This procedure requires stored information of carrier frequencies
      and optionally also information on cell parameters, from
      previously received measurement control information elements
      or from previously detected cells. Once the UE has found a
      suitable cell the UE shall select it. If no suitable cell
      is found the Initial Cell Selection procedure shall be started.
  NOTE 1: Priorities between different frequencies or RATs provided to
        the UE by system information or dedicated signalling are not
        used in the cell selection process.
  NOTE 2: If BL UE, UE in enhanced coverage or NB-IoT UE has been
        provisioned with EARFCN, the UE may use this information
        during Initial Cell Selection and Stored Information Cell
        Selection to find a suitable cell.
  NOTE 3: If T_{noService} is running, the UE may choose not to perform the
        cell selection procedures.
  NOTE 4: If T_{noService} is running, the UE may choose to enter Any Cell
        Selection state.
```

The measurement rules for cell re-selection in the 3GPP documents may be modified as follows (the modifies parts are underlined):

5.2.4.2 Measurement rules for cell re-selection
For NB-IoT measurement rules for cell re-selection is defined in clause
5.2.4.2.a.
When evaluating Srxlev and Squal of non-serving cells for reselection
purposes, the UE shall use parameters provided by the serving cell.
Following rules are used by the UE to limit needed measurements:

| | |
|---|---|
| - | If T_{noService} is running, the UE may choose not to perform serving |
| | cell measurements. |
| - | If the serving cell fulfils Srxlev > S_{IntraSearchP} and Squal > |
| | S_{IntraSearchQ} or T_{noService} is running, the UE may choose not |
| | to perform intra-frequency measurements. |
| - | Otherwise, the UE shall perform intra-frequency measurements. |
| - | The UE shall apply the following rules for E-UTRAN |
| | inter-frequencies and inter-RAT frequencies which are |
| | indicated in system information and for which |
| | the UE has priority provided as defined in 5.2.4.1: |

| | |
|---|---|
| - | For an E-UTRAN inter-frequency or inter-RAT frequency with a |
| | reselection priority higher than the reselection priority of |
| | the current E-UTRA frequency the UE shall perform |
| | measurements of higher priority E-UTRAN inter-frequency or |
| | inter-RAT frequencies according to TS 36.133 [10]. |
| - | For an E-UTRAN inter-frequency with an equal or lower |
| | reselection priority than the reselection priority of the |
| | current E-UTRA frequency and for inter-RAT frequency with |
| | lower reselection priority than the reselection |
| | priority of the current E-UTRAN frequency: |

| | |
|---|---|
| - | If the serving cell fulfils Srxlev > S_{nonIntraSearchP} and Squal > |
| | S_{nonIntraSearchQ} or T_{noService} is running, the UE may choose |
| | not to perform measurements of E-UTRAN inter-frequencies |
| | or inter-RAT frequency cells of equal or lower priority |
| | unless the UE is triggered to measure an E-UTRAN |
| | inter-frequency which is configured with |
| | redistributionInterFreqInfo. |
| - | Otherwise, the UE shall perform measurements of E-UTRAN |
| | inter-frequencies or inter-RAT frequency cells of equal or |
| | lower priority according to TS 36.133 [10]. |

| | |
|---|---|
| - | If the UE supports relaxed monitoring and s-SearchDeltaP is |
| | present in SystemInformationBlockType3, the UE may further |
| | limit the needed measurements, as specified in clause 5.2.4.12. |

5.2.4.2a Measurement rules for cell re-selection for NB-IoT
When evaluating Srxlev and Squal of non-serving cells for reselection
purposes, the UE shall use parameters provided by the serving cell.
Following rules are used by the UE to limit needed measurements:

| | |
|---|---|
| - | If T_{noService} is running, the UE may choose not to perform |
| | serving cell measurements. |
| - | If the serving cell fulfils Srxlev > S_{IntraSearchP} or T_{noService} is |
| | running, the UE may choose not to perform intra-frequency |
| | measurements. |
| - | Otherwise, the UE shall perform intra-frequency |
| | measurements. |
| - | The UE shall apply the following rules for NB-IoT |
| | inter-frequencies which are indicated in system information: |

| | |
|---|---|
| - | If the serving cell fulfils Srxlev > S_{nonIntraSearchP} |
| | or T_{noService} is running, the UE may choose |
| | not to perform inter-frequency measurements. |
| - | Otherwise, the UE shall perform inter-frequency measurements. |

| | |
|---|---|
| - | If the UE supports relaxed monitoring and s-SearchDeltaP is |

present in SystemInformationBlockType3-NB, the UE may further limit
the needed measurements, as specified in clause 5.2.4.12.

The underlined texts are exemplary description, which may include all the possible operations explained above. For example, when the timer T_{noService} is running, the UE may not perform any type of the cell measurements as indicated above.

In the second preferred scenario, the UE determines an offset, which includes the first offset and the second offset indicated above, and it may be represented as, Qoffset_{noService}. The offset may be applied to at least one of neighboring cell measurements triggering parameters, which include:
1. The measured RSRP of the neighboring cell, Srxlev;
2. Measured RSRQ of the neighboring cell, Squal;
3. The measured RSRP threshold of the neighboring cell, which includes the intra frequency search signal strength, S_{IntraSearchP}, and the non intra frequency search signal strength, S_{nonIntraSearchP}; and
4. The measured RSRQ threshold of the neighboring cell, which includes the intra frequency search signal strength, S_{IntraSearchQ}, and the non intra frequency search signal strength, S_{nonIntraSearchQ}.

The offset is applied for cell reselection, and the offset is applied during the offset durations. The UE may receive the offset and/or the time duration from the BS or from the network.

With the offset, the UE determines an offset value of the above parameters, or an extended value of the above parameters, and the UE applies the offset or the extended value as follows:
1. The UE may apply the offset to at least one of the neighboring cell measurement triggering parameters for cell reselection based on the location of the UE, speed or mobility state. Or, upon receiving the network configuration, the UE applies the offset; or at a starting time estimated by UE or configured by network, the UE applies the offset.
2. The UE may not apply the offset to at least one of the neighboring cell measurement triggering parameters for cell reselection based on the location of the UE, speed or mobility state. Or, upon receiving the network configuration, the UE stops applying the offset; or at a starting time estimated by UE or configured by network, the UE stops applying the offset.

In one embodiment, the UE may report the capability of applying the offset, Qoffset_{noService}, to the network. The UE may report the availability of estimated the offset, Qoffset_{noService}, to the network.

During the RRC establishment process, the RRC re-establishment process, the RRC resume process, the RRC reconfiguration process, the RRC release process, the RRC attach process, the RRC de-attach process, or the TAU process, the UE may report the estimated Qoffset_{noService} to the network; and/or the UE may report the request of applying Qoffset_{noService} to the network.

In one scenario, after receiving the offset from the network, the UE may report to the network the acceptance or rejection of Qoffset_{noService} indicated by the network.

The offset may be used in the 3GPP documents, and the 3GPP documents may be modified as follows (the modifies parts are underlined):

```
For UEs other than NB-IoT UEs:
  Srxlev = Qᵣₓₗₑᵥₘₑₐₛ − (Qᵣₓₗₑᵥₘᵢₙ + Q_{rxlevminoffset}) − Pcompensation −
  Qoffsetₜₑₘₚ + Qoffset_{noService}
  Squal = Q_{qualmeas} − (Q_{qualmin} + Q_{qualminoffset}) − Qoffsetₜₑₘₚ+
  Qoffset_{noService} where:
```

| | |
|---|---|
| Qoffset_{noService} | Offset temporarily applied to weak |
| | coverage time (dB) |
| | (dB) |

```
For NB-IoT UEs:
  Srxlev = Qᵣₓₗₑᵥₘₑₐₛ − Qᵣₓₗₑᵥₘᵢₙ − Pcompensation − Qoffsetₜₑₘₚ+
  Qoffset_{noService}
  Squal = Q_{qualmeas} − Q_{qualmin} − Qoffsetₜₑₘₚ+ Qoffset_{noService}
where:
```

| | |
|---|---|
| Qoffset_{noService} | Offset temporarily applied to weak |
| | coverage time (dB) |
| | (dB) |

The above underlined texts are exemplary description, which may include all the possible operations explained above.

For example, the offset Qoffset_{noService} may be applied to the intra frequency search signal strength, S_{IntraSearchP}, the non intra frequency search signal strength, S_{nonIntraSearchP}; the measured RSRQ threshold of the neighboring cell, which includes the intra frequency search signal strength, S_{IntraSearchQ}, and the non intra frequency search signal strength, S_{nonIntraSearchQ}.

In the third preferred scenario, an extended value or an offset to at least one of the relaxed monitoring parameters for at least one type of cell measurement, are estimated by the UE or indicated to the UE by the BS or the network. The relaxed monitoring parameters include:
1. A timer duration since measurements for cell reselection were last performed, T_{Search};
2. The duration required to fulfill the cell quality tolerance threshold, T_{SearchDeltaP}; and
3. Cell quality tolerance threshold S_{SearchDeltaP}.

With the offset, the UE determines an offset value of the above parameters, or an extended value of the above parameters, and the UE applies the offset or the extended value as follows:
1. The UE may apply the offset to at least one of the relaxed monitoring parameters for at least one type of cell measurement process based on the location of the UE, speed or mobility state. Or, upon receiving the network configuration, the UE applies the offset.
2. The UE may not apply the offset to at least one of the relaxed monitoring parameters for at least one type of cell measurement process based on the location of the UE, speed or mobility state. Or, upon receiving the network configuration, the UE stops applying the offset.

In one embodiment, the UE may report the capability of applying the at least one of the relaxed monitoring parameters to the network. The UE may report the availability of at least one of the estimated relaxed monitoring parameters to the network.

During the RRC establishment process, the RRC re-establishment process, the RRC resume process, the RRC reconfiguration process, the RRC release process, the RRC attach process, the RRC de-attach process, or the TAU process, the UE may report at least one of the estimated relaxed monitoring parameters to the network; and/or the UE may report the request of applying at least one of the estimated relaxed monitoring parameters to the network.

In one scenario, after receiving the offset from the network, the UE may report to the network the acceptance or rejection of at least one of the estimated relaxed monitoring parameters indicated by the network.

The relaxed monitoring parameters may be used in the 3GPP documents, and the 3GPP documents may be modified as follows (the modifies parts are underlined):

5.2.4.12 Relaxed monitoring
5.2.4.12.0 Relaxed monitoring measurement rules
When the UE is required to perform intra-frequency or inter-
frequency measurement according to the measurement rules in clause
5.2.4.2 or 5.2.4.2a, the UE may choose not to perform
intra-frequency or inter-frequency measurements when:

| | |
|---|---|
| - | The relaxed monitoring criterion in clause 5.2.4.12.1 is |
| | fulfilled for a period of T_{SearchDeltaP}, and |
| - | Less than 24 hours or T_{Search} have passed since |
| | measurements for cell reselection were last performed, and |
| - | The UE has performed intra-frequency or inter-frequency |
| | measurements for at least T_{SearchDeltaP} after selecting or |
| | reselecting a new cell. |

5.2.4.12.1 Relaxed monitoring criterion
The relaxed monitoring criterion is fulfilled when:

| | |
|---|---|
| - | (Srxlev_{Ref} − Srxlev) < S_{SearchDeltaP} |

Where:

| | |
|---|---|
| - | Srxlev = current Srxlev value of the serving cell (dB). |
| - | Srxlev_{Ref} = reference Srxlev value of the serving cell (dB), |
| | set as follows: |

| | |
|---|---|
| - | After selecting or reselecting a new cell, or |
| - | If (Srxlev − Srxlev_{Ref}) > 0, or |
| - | If the relaxed monitoring criterion has not been |
| | met for T_{SearchDeltaP}: |

| | |
|---|---|
| - | the UE shall set the value of Srxlev_{Ref} to |
| | the current Srxlev value of the serving cell; |

| | |
|---|---|
| - | T_{SearchDeltaP} = 5 minutes, or the eDRX cycle length if |
| | eDRX is configured and the eDRX cycle length is |
| | longer than 5 minutes, or configured by network. |

The relaxed monitoring parameters may be defined in the 3GPP documents as follows:

```
CellReselectionInfoCommon-v17xy ::= SEQUENCE {
  s-SearchDeltaP-r17 ENUMERATED {dB6, dB9, dB12,
dB15, dBx/inf}
  t-SearchDeltaP-r17 ENUMERATED {t1, t2, t3, ...}
  t-Search-r18 ENUMERATED {t4, t5, t6, ...}
}
```

The above underlined texts are exemplary description, which may include all the possible operations explained above. For example, the value of the relaxed monitoring parameters, such as the T_{SearchDeltaP} may be 5 dB, or other values.

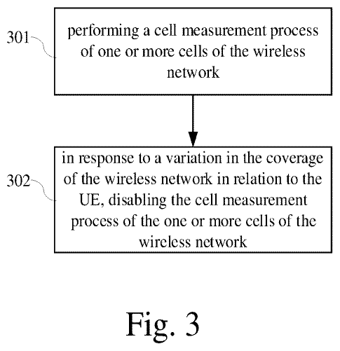

FIG. 3 illustrates a method for performing cell measurement process according to some embodiments of the present disclosure.

In step 301, the UE performs a cell measurement process of one or more cells of the wireless network, the network has variable coverage, the network may be an NTN, or a network that is still under construction thus the coverage is discontinuous, or an ABS, the ABS is moving so that the coverage is variable. The coverage information may be determined by the UE itself, or received from the network or the BS.

In step 302, in response to a variation in the coverage of the wireless network in relation to the UE, the UE disables the cell measurement process of the one or more cells of the wireless network. The variation in the coverage of the wireless network in relation to the UE is associated with the coverage of the wireless network being discontinued. For instance, on the edge of the wireless network, the DL signal of the wireless network is extremely weak, and if the UE moves outward a distance, the DL signal of the network cannot be detected, in this case, the coverage wireless network may be discontinued.

At BS side, the BS in a wireless network with a variable coverage may transmit to one or more User Equipment (UE), coverage information of one or more cells that are associated with the wireless network in relation to the one or more UE; and in response to a variation in the coverage of the wireless network in relation to one or more UE, the BS may transmit the coverage information of the one or more cells.

The cell measurement process relates to at least measuring one of a serving cell of the UE, searching for and/or measuring signal strength of a neighboring cell of the serving cell, or searching for and/or measuring signal strength of a suitable cell.

The UE may further determine the coverage information of the wireless network, or receives the coverage information from the wireless network. The coverage information includes at least one of the following information:
1. A first indication for indicating an area of a serving cell of the UE where cell quality is below a first threshold;
2. A first time duration when the cell quality is below the first threshold;
3. A second indication for indicating an area of a serving cell of the UE where cell quality is above a second threshold;
4. A second time duration when the cell quality is above the second threshold;
5. A third indication for activating or deactivating the cell measurement process;
6. A third time duration for activating or deactivating the cell measurement process;
7. A first offset of a measured cell quality value, the first offset may be applied to the measured RSRP, Srxlev, and/or the measured RSRQ, Squal;
8. A first offset duration for applying the first offset of the measured cell quality value;
9. A second offset of a measured cell quality value threshold, the second offset may be applied to the RSRP threshold, S_{IntraSearchP} or S_{nonIntraSearchP}, and/or the RSRQ threshold, S_{IntraSearchQ} or S_{nonIntraSearchQ};
10. A second offset duration for applying the second offset of the measured cell quality value;
11. A third offset of a cell quality tolerance threshold, the third offset may be applied to the cell quality tolerance threshold, S_{SearchDeltaP};
12. A third offset duration for applying the third offset of the measured cell quality value; and
13. A maximum time duration between a last cell measurement process and a current cell measurement process, the maximum time duration may be 24 hours.

In some embodiment, the UE may transmit a request for the coverage information in at least one of the following procedures: a RRC establishment procedure; a RRC re-establishment procedure; a RRC resume procedure; a RRC reconfiguration procedure; a RRC release procedure; a RRC attach procedure; a RRC de-attach procedure; a TAU procedure.

In some embodiment, the UE may receive the coverage information from the network, and the coverage information is included in a message during at least one of the following procedures: a RRC establishment procedure, a RRC re-establishment procedure, a RRC resume procedure, a RRC reconfiguration procedure, a RRC release procedure, a RRC attach procedure, a RRC de-attach procedure or a TAU procedure, or transmitted in system information broadcast. For example, in step 201 in FIG. 2, the UE receives the coverage information from the BS.

In some embodiment, the UE may receive the modification information for the coverage information of the wireless network being associated with the wireless network with variable coverage during at least one of the following procedures: a RRC establishment procedure; a RRC re-establishment procedure; a RRC resume procedure; a RRC reconfiguration procedure; a RRC release procedure; a RRC attach procedure; a RRC de-attach procedure; a TAU procedure. For example, after receiving the coverage information from the UE, the BS may adjust the coverage information, then transmit the modification information to the UE.

In some embodiment, the UE may activate a first timer when the cell quality of the wireless network with variable coverage is below a first threshold, or at a time indicated by a first time duration, or when the UE enters the IDLE mode. The UE may stop the cell measurement process when the first timer is running. The UE may perform the cell measurement process when the first timer is not running or before transmitting uplink data.

In some embodiment, the UE may apply at least one offset in the following manners: the UE may apply the first offset to the measured cell quality value, the UE may apply the second offset to the measured cell quality value threshold, and the UE may apply the third offset to the measured cell quality tolerance threshold.

The UE may apply the offsets in the corresponding offset durations, for example, the UE may apply the first offset to the measured cell quality value within the first offset duration, the UE may apply the second offset to the measured cell quality value threshold within the second offset duration, the UE may apply the third offset to the measured cell quality tolerance threshold within the third offset duration.

In some embodiments, the UE may transmit a third indication indicating whether the UE is capable of performing the cell measurement, i.e. the UE transmits the capability of performing the cell measurement process to the BS.

In some embodiments, the UE may transmit, to the wireless network, a fourth indication indicating whether coverage information determined by the UE is available or not, i.e. the UE transmits the availability of the coverage information to the BS.

In some embodiments, the UE may transmit, to the wireless network, the coverage information determined by the UE in at least one of the following procedures: a RRC establishment procedure; a RRC re-establishment procedure; a RRC resume procedure; a RRC reconfiguration procedure; a RRC release procedure; a RRC attach procedure; a RRC de-attach procedure; a TAU procedure.

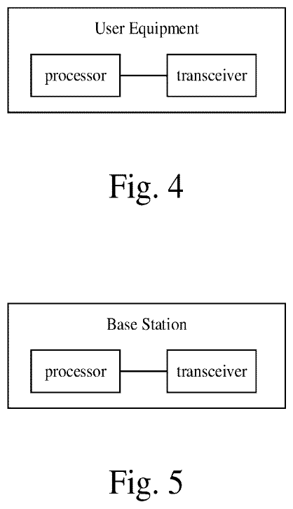

FIG. 4 depicts a block diagram of a UE according to the embodiments of the present disclosure. The UE 101 may include a processor and a transceiver, which is coupled to the processor. In one embodiment, the UE 101 may include a non-transitory computer-readable medium having stored thereon computer-executable instructions, a transceiver, and a processor coupled to the non-transitory computer-readable medium and the transceiver. The computer executable instructions can be programmed to implement a method with the transceiver and the at least one processor. The method according to an embodiment of the present disclosure, for example, is the method shown in FIG. 2.

FIG. 5 depicts a block diagram of a BS according to the embodiments of the present disclosure. The BS 102 may include a processor and transceiver. In one embodiment, the BS may include a non-transitory computer-readable medium having stored thereon computer-executable instructions, a transceiver, and a processor coupled to the transceiver. The computer executable instructions can be programmed to implement a method with the transceiver and the at least one processor. The method according to an embodiment of the present disclosure, for example, is the method shown in FIG. 2.

The method of the present disclosure can be implemented on a programmed processor. However, controllers, flowcharts, and modules may also be implemented on a general purpose or special purpose computer, a programmed microprocessor or microcontroller and peripheral integrated circuit elements, an integrated circuit, a hardware electronic or logic circuit such as a discrete element circuit, a programmable logic device, or the like. In general, any device that has a finite state machine capable of implementing the flowcharts shown in the figures may be used to implement the processing functions of the present disclosure.

While the present disclosure has been described with specific embodiments thereof, it is evident that many alternatives, modifications, and variations will be apparent to those skilled in the art. For example, various components of the embodiments may be interchanged, added, or substituted in other embodiments. Also, all of the elements shown in each Fig. are not necessary for operation of the disclosed embodiments. For example, one skilled in the art of the disclosed embodiments would be capable of making and using the teachings of the present disclosure by simply employing the elements of the independent claims. Accordingly, the embodiments of the present disclosure as set forth herein are intended to be illustrative, not limiting. Various changes may be made without departing from the spirit and scope of the present disclosure.

In this disclosure, relational terms such as “first,” “second,” and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “a,” “an,” or the like does not, without more constraints, preclude the existence of additional identical elements in the process, method, article, or apparatus that comprises the element. Also, the term “another” is defined as at least a second or more. The terms “including,” “having,” and the like, as used herein, are defined as “comprising.”

1. A method performed by a user equipment (UE) in a wireless network, comprising:
performing a cell measurement process of one or more cells of the wireless network; and
in response to a variation in coverage of the wireless network in relation to the UE, disabling the cell measurement process of the one or more cells of the wireless network.

2. The method of claim 1, wherein the variation in the coverage of the wireless network in the relation to the UE includes the coverage of the wireless network being discontinued.

3. The method of claim 1, wherein the cell measurement process includes at least one of:
measuring a serving cell of the UE;
searching for a first signal strength of a neighboring cell of the serving cell;
measuring the first signal strength of the neighboring cell of the serving cell;
searching for a second signal strength of a suitable cell; or
measuring the second signal strength of the suitable cell.

4. The method of Chaim claim 1, further comprising:
at least one of determining coverage information of the wireless network or receiving the coverage information from the wireless network.

5. The method of claim 1, further comprising:
transmitting a request for coverage information in a procedure that includes at least one of:
a radio resource control (RRC) establishment procedure;
a RRC re-establishment procedure;
a RRC resume procedure;
a RRC reconfiguration procedure;
a RRC release procedure;
a RRC attach procedure;
a RRC de-attach procedure; or
a tracking area update (TAU) procedure.

6. The method of claim 1, wherein coverage information is received from the wireless network, the coverage information included in a message transmitted in a system information broadcast.

7. (canceled)

8. The method of claim 1, further comprising:
activating a timer based on at least one of a cell quality of the wireless network is below a threshold, a time duration, or when the UE enters an idle mode.

9. The method of claim 8, further comprising:
stopping the cell measurement process when the timer is running.

10. The method of claim 8, further comprising:
performing the cell measurement process when the first timer is not running or before transmitting uplink data within the wireless network.

11. (canceled)

12. (canceled)

13. The method of claim 1, further comprising:
transmitting, to the wireless network, an indication that the UE is capable of performing the cell measurement process.

14. The method of claim 1, further comprising:
transmitting, to the wireless network, an indication that coverage information determined by the UE is available coverage information applied to the performing the cell measurement process.

15. (canceled)

16. A user equipment (UE) for wireless communication, comprising:
at least one memory; and
at least one processor coupled with the at least one memory and configured to cause the UE to:
perform a cell measurement process of one or more cells of a wireless network; and
disable the cell measurement process of the one or more cells of the wireless network in response to a variation in coverage of the wireless network in relation to the UE.

17. The UE of claim 16, wherein the variation in the coverage of the wireless network in the relation to the UE includes the coverage of the wireless network being discontinued.

18. The UE of claim 16, wherein the cell measurement process includes the at least one processor configured to cause the UE to at least one of:
measure a serving cell of the UE;
search for a first signal strength of a neighboring cell of the serving cell;
measure the first signal strength of the neighboring cell of the serving cell;
search for a second signal strength of a suitable cell; or
measure the second signal strength of the suitable cell.

19. The UE of claim 16, wherein the at least one processor is configured to cause the UE to at least one of determine coverage information of the wireless network or receive the coverage information from the wireless network.

20. The UE of claim 16, wherein the at least one processor is configured to cause the UE to transmit a request for coverage information in a procedure that includes at least one of:
a radio resource control (RRC) establishment procedure;
a RRC re-establishment procedure;
a RRC resume procedure;
a RRC reconfiguration procedure;
a RRC release procedure;
a RRC attach procedure;
a RRC de-attach procedure; or
a tracking area update (TAU) procedure.

21. The UE of claim 16, wherein the at least one processor is configured to cause the UE to receive coverage information from the wireless network, the coverage information included in a message transmitted in a system information broadcast.

22. The UE of claim 16, wherein the at least one processor is configured to cause the UE to activate a timer based on at least one of a cell quality of the wireless network is below a threshold, a time duration, or when the UE enters an idle mode.

23. The UE of claim 16, wherein the at least one processor is configured to cause the UE to transmit, to the wireless network, an indication that the UE is capable of performing the cell measurement process.

24. A processor for wireless communication, comprising:
at least one controller coupled with at least one memory and configured to cause the processor to:
perform a cell measurement process of one or more cells of a wireless network; and
disable the cell measurement process of the one or more cells of the wireless network in response to a variation in coverage of the wireless network relative to a user equipment (UE).
